(19) United States
(12) Patent Application Publication
(10) Pub. No.: US 2012/0330498 A1
(43) Pub. Date: Dec. 27, 2012

(54) SECURE DATA STORE FOR VEHICLE NETWORKS

(75) Inventors: Wes A. Nagara, Commerce Twp., MI (US); Animesh Das, Farmington Hills, MI (US); Paul Morris, Ann Arbor, MI (US)

(73) Assignee: VISTEON GLOBAL TECHNOLOGIES, INC., Van Buren Twp., MI (US)

(21) Appl. No.: 13/166,373

(22) Filed: Jun. 22, 2011

(51) Int. Cl. G06F 19/00

(52) U.S. Cl. 701/33.2; 701/29.1

(57) ABSTRACT

A vehicle network system includes at least one module connected to a system of a vehicle, and a connectivity module. The connectivity module has a data store in communication with the at least one module. The connectivity module can write data to the data store. The data store permits read-only access of the data from the at least one module by a communications device.

### FIELD OF THE INVENTION

The invention relates to a vehicle network and, more particularly, to a secure network for a vehicle.

### BACKGROUND OF THE INVENTION

The development timeline for vehicle network systems can be categorized into three different eras, namely: early; later; and modern. Early vehicle network systems used lower-level networks such as a controller-area network (CAN). The CAN is a vehicle bus standard designed to allow microcontrollers and devices to communicate with each other within the vehicle without a host computer. The CAN networks operate on a message-based protocol that “broadcast” messages, with each module listening for the broadcasted message intended for each module. If a particular module receives a message intended for the particular module, the message is processed, regardless of an originating source for the message. All connections between modules in the early vehicle systems were “bi-directional”, meaning that full data read/write access was available between all modules. However, the early vehicle CAN networks employed simple protocols, included a smaller number of modules, and were relatively isolated compared to modern networks.

Later vehicle network systems included on-board diagnostics such as an OBD-II standard. OBD-II is a government mandated standard that provides a vehicle owner or a repair technician access to various vehicle systems via a common access port. The OBD-II standard enables “back-door” access for diagnostics, firmware updates, etc. Typically, certain security or module identification codes must be provided in order to permit writing to the modules.

Modern vehicle network systems include connectivity modules such as an audio head unit (AHU) that communicates with various portable consumer electronic (CE) devices such as smart phones, computer tablets, etc. The AHU also can be accessed via USB ports and the like. The connectivity modules such as AHUs present in modern vehicle networks create “front doors” to the modern vehicle networks where access is known. Being known, hardware devices and software for interconnection with the modern vehicle network are being rapidly developed. However, because the vehicle electronics are becoming increasingly interconnected, the connectivity modules and the AHUs also create new paths for malicious code to reach critical vehicle systems. Audio and infotainment product offerings are especially vulnerable, as both wired (e.g., USB) and wireless (e.g., Bluetooth, WiFi, 3G, etc.) interconnects are becoming more prevalent in modern vehicles. Hacking into powertrain modules and chassis modules via the connectivity modules, in particular, presents undesirable scenarios for the typical vehicle owner.

There is a continuing need for a vehicle network system to separate critical vehicle modules and sub-networks (e.g., powertrain, chassis, etc.) from non-critical modules and sub-networks (audio, navigation, etc.). Desirably, the vehicle network system provides a new layer of security that can be implemented on “lower-layer” networks like CAN.

### SUMMARY OF THE INVENTION

In concordance with the instant disclosure, a vehicle network system to separate critical vehicle modules and sub-networks (e.g., powertrain, chassis, etc.) from non-critical modules and sub-networks (audio, navigation, etc.), and which provides a new layer of security that can be implemented on “lower-layer” networks like CAN, is surprisingly discovered.

In one embodiment, a vehicle network system includes at least one module connected to a system of a vehicle. The vehicle network system further includes a connectivity module having a data store in communication with the at least one module. The data store permits read-only access of data from the at least one module by a communications device.

In another embodiment, a vehicle network system includes a plurality of modules connected to one another over a network. Each of the modules is connected to a system of a vehicle. The vehicle network system also includes an on-board diagnostic module in communication with the plurality of modules. The on-board diagnostic module permits read/write access to the plurality of modules. The vehicle network system further includes a connectivity module having a data store in communication with the plurality of modules. The data store permits read-only access of data from the plurality of modules by a communications device.

In a further embodiment, a method for operating the vehicle network system includes the steps of: permitting the communications device to communicate with the connectivity module; causing data to be written by the at least one module to the data store of the connectivity module for read-only access by the communications device if the communication from the communications device to the connectivity module is a read request; and blocking a writing of data to the at least one module by the communications device if the communication from the communications device to the connectivity module is a write request.

In exemplary embodiments, the vehicle network system adapts to new data requests from non-critical modules. For example, if the buffer only stored speed data, but a new non-critical module was added that wanted to know wiper status, the data store buffer would be modified in to add the additional data. The adaptive vehicle network system of the present disclosure enables the data store buffer to learn new data requests, and adjust accordingly. The vehicle network system also may have a verification process and backup, and in the case of a crash of the vehicle network system, a back image will run the system temporally until the backup image is restored.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic diagram of a vehicle network system according to one embodiment of the present disclosure, including a software-based data store permitting read-only access between vehicle modules and a portable CE device;

FIG. 2 is a schematic diagram of a vehicle network system according to another embodiment of the present disclosure, including a hardware-based data store permitting read-only access between vehicle modules and a portable CE device;

FIG. 3 is a schematic diagram of an exemplary data store for use with the vehicle network system of the present disclosure; and

FIG. 4 is a schematic diagram showing operation of the vehicle network system depicted in FIGS. 1-3 under a variety of operating conditions.

### DETAILED DESCRIPTION OF THE EMBODIMENTS

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

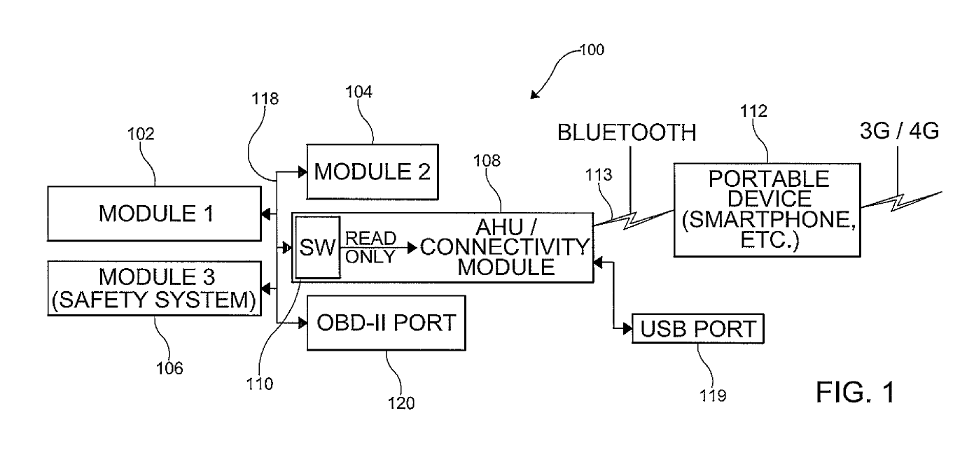

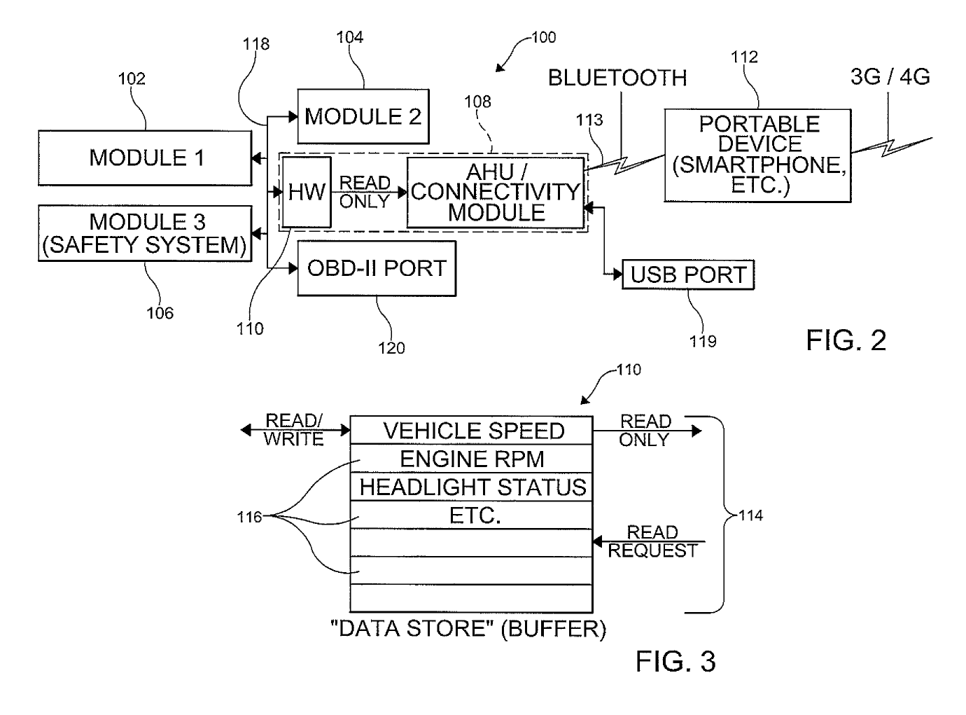

As shown in FIGS. 1 and 2, the vehicle network system 100 of the present disclosure includes at least one module 102, 104, 106 connected to a system (not shown) of a vehicle (not shown). The system may be a critical vehicle system such as one of a powertrain system and a chassis system, as nonlimiting examples. The system may be a noncritical vehicle system such as one of an audio system and a navigation system, as nonlimiting examples. A skilled artisan should understand that other types of critical and noncritical vehicle systems may be connected to the at least one module 102, 104, 106, within the scope of the present disclosure.

The vehicle network system further includes a connectivity module 108. The connectivity module 108 is in communication with the at least one module 102, 104, 106. In particular, the connectivity module 108 can send requests for data to the at least one module 102, 104, 106, and can receive requested data from the at least one module 102, 104, 106. The connectivity module 108 includes a data store 110. The data store 110 may be implemented as at least one of a software-based data store 110, shown in FIG. 1, and a hardware-based data store 110, shown in FIG. 2, as desired.

The data store 110 permits read-only access of the at least one module 102, 104, 106 by a communications device 112. In particular, the data store 110 permits read-only access of the entire network connecting multiple ones of the at least one module 102, 104, 106. The communications device 112 may communicate with the connectivity module 108 with a wireless signal 113 such as a Bluetooth signal, for example. Other types of wireless signals including radio signals may also be used within the scope of the disclosure. As a nonlimiting example, the communications device 112 may be mobile phone such as a smart phone or another portable consumer electronics device with wireless capability such as a computer tablet, as desired. The communications device 112 may further be a wired device having a capability to communicate with the connectivity module 108 through a wire port such as a USB port. The communications device 112 may have both wireless capability and wired capability.

As shown in FIG. 3, the data store 110 includes a memory buffer 114 that temporarily holds data 116 from the at least one module 102, 104, 106 for the read-only access by the communications device 112. As nonlimiting examples, the data 116 may include information such as vehicle speed, engine RPM, headlight status, and the like. Other information relevant to the operation and performance of the vehicle may also be stored in the buffer 114 for read-only access by the communications device 112.

The at least one module 102, 104, 106 may have read/write access to the data store 110 for writing the data 116 to the buffer 114, for subsequent read-only access of the data 116 in the buffer 114 by the communications device 112. The data store 110 may further include a processor (not shown), in the case of the hardware implementation, for executing a program to monitor and approve/disapprove requests for the data 116 from the communications device 112. The hardware-based data store 110 may have a “read-only” port, for example, and process a “proxy” that can read any of the data 116 broadcast over the network, but prohibits writing to the at least one module 102, 104, 106 over the network. In the case of the software implementation, the data store 110 may include security software such as an anti-virus program and the like, and also prohibits writing over the network. It should be appreciated that the data store 110, in either the hardware implementation or the software implementation forms, may thereby block “write” requests by the communications device 112, and thus prevent “back door” access to the vehicle system 100 by unauthorized external sources such as a hacker.

With renewed reference to FIGS. 1 and 2, the at least one module 102, 104, 106 may include a plurality of modules 102, 104, 106. For example, the plurality of modules 102, 104, 106 may include a first module 102, a second module 104, and a third module 106, each directly connected to a different system of the vehicle. In illustrative embodiments, each of the plurality of modules 102, 104, 106 is connected to a critical system or sub-system of the vehicle. In such a case, noncritical subsystems such as audio and infotainment systems of the vehicle are only permitted to communicate with the plurality of modules 102, 104, 106 through the data store 110, thereby limiting access, and thus, access by the communications device 112, to the critical system as “read-only”. In another embodiment, the first module 102 and the second module 104 may be connected to noncritical systems of the vehicle, and the third module 106 may be connected to a critical system of the vehicle such as a safety system, each of which is buffered from the communications device 112 by the data store 110. A skilled artisan should understand that other connections between the plurality of modules 102, 104, 106 and the critical and noncritical systems of the vehicle may also be employed, but that the critical systems are always buffered from the communications device 112 by the data store 110.

In addition to being individually connected to different systems of the vehicle, the first module 102, the second module 104, and the third module 106 are also interconnected. In particular, the first module 102, the second module 104, and the third module 106 are in communication with each other over a network 118 such as a controller-area network (CAN), a media oriented system transport network (MOST), or other networks. For example, there may be read/write access between each of the first module 102, the second module 104, and the third module 106 over the network 118. However, the vehicle network system 100 of the present disclosure relies on the fact that the network 118 is substantially isolated in the vehicle through use of the data store 110, and malicious sources are therefore not able to access the network 118. One of ordinary skill in the art may also limit communication between certain ones of the plurality of modules 102, 104, 106, as desired.

Although the read/write access by the communications device 112 is blocked by the data store 110, it should also be understood that the data store 110 can also block read/write access by other external sources communicating with the connectivity module 108. For example, the vehicle network system 100 may include a port 119 such as a USB port, which permits direct electrical communication between the connectivity module 108 and a wired device (not shown) such as a personal computer or the like.

The vehicle network system 100 of the present disclosure may also have an on-board diagnostic module 120 in addition to the connectivity module 108. The on-board diagnostic module 120 may include an OBD-II standard port, for example. The on-board diagnostic module 120 is in communication with the at least one module 102, 104, 106. The on-board diagnostic module 120 permits “back door” access to the network 118. For example, the on-board diagnostic module 120 may be in communication with the first module 102, the second module 104, and the third module 106 via the network 118. The on-board diagnostic module 120 thereby by-passes the data store 110 and permits read/write access of the plurality of modules 102, 104, 106, for example, to modify software residing on at least one of the modules 102, 104, 106 over the network 118. It should be appreciated that the read/write access of the plurality of modules 102, 104, 106 through the on-board diagnostic module 120 is performed only in an authorized manner.

The present disclosure includes a method for operating the vehicle network system 100. The method first includes a step of permitting the communications device 112 to communicate with the connectivity module 108. Data is caused to be written by the at least one module 102, 104, 106 to the data store 110 of the connectivity module 108 for read-only access by the communications device 112, if the communication from the communications device 112 to the connectivity module 108 is a read request. As a nonlimiting example, the read request may be a request for performance data related to the system to which the at least one module 102, 104, 106 is connected. Conversely, a writing of data to the at least one module 102, 104, 106 by the communications device 112 is blocked by the data store 110 if the communication from the communications device 112 to the connectivity module is a write request. As a nonlimiting example, the write request may be a request to modify software of the at least one module 102, 104, 106. Where the system includes the on-board diagnostic module 120, the method may include a step of permitting the writing of data to the at least one module 102, 104, 106 through the on-board diagnostic module, even when such writing of data by the communications device 112 is prohibited by the data store 110 of the disclosure.

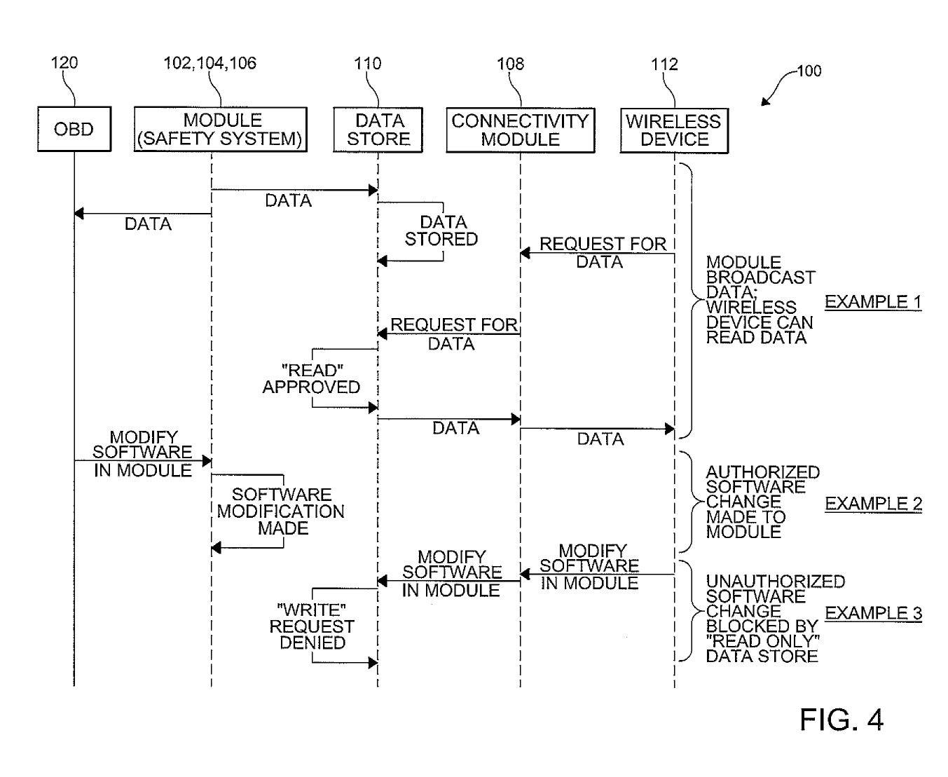

FIG. 4 illustrates an operation of the vehicle network system 100 of the disclosure under three different scenarios involving the at least one module 102, 104, 106 as a safety system of the vehicle. In a first example, the communications device 112 makes a request for data, for example, vehicle speed data, to the connectivity module 108. The connectivity module 108 then makes a request for data to the data store 110. The data store 110 receives the data from the at least one module 102, 104, 106. The data store 110 performs an approval procedure on the request for data and, if the request for data is approved, supplies the data to the connectivity module 108. The connectivity module 108 in turn supplies the data to the communications device 112. The data store 110 thereby presents the data to the communications device 112 in a read-only manner. The first example further shows that the data from the at least one module 102, 104, 106 can be communicated directly from the at least one module 102, 104, 106 through the on-board diagnostic module 120, which by-passes the data store 110.

In a second example shown in FIG. 4, an authenticated maintenance device (not shown) is connected to the on-board diagnostic module 120 of the vehicle network system 100. A request to modify software in the at least one module 102, 104, 106 is made from the on-board diagnostic module 120 directly to the at least one module 102, 104, 106. The software modification is thereby made to the at least one module 102, 104, 106 in an authorized manner, and the data store 110 is not used to monitor or approve the request to modify software in the at least one module 102, 104, 106 made at the on-board diagnostic module 120.

A third example shown in FIG. 4 contrasts with the second example. In the third example, the communications device 112 makes a request to modify software in the at least one module 102, 104, 106. The request is made to the connectivity module 108, which in turn forwards the request to the data store 110. The data store 110, which is responsible for monitoring and approving requests, and which also only permits read-only access to the communications device 112, denies the request to modify the software as an unauthorized “write” request. The data store 110 of the present disclosure thereby secures the vehicle network system 100 from unauthorized and possibly malicious hacking into critical systems and sub-systems of the vehicle through the communications device 112.

Advantageously, the vehicle network system 100 of the present disclosure permits data to be read from critical networks of the vehicle, but also prohibits writing data back to the same critical networks. For example, a navigation system may be permitted to reach vehicle speed data from a powertrain module, but if a virus or other malicious software code tries to take advantages of that path, it will be blocked from writing data back to the power train module. The current solution relies on the premise that the network 118 is basically isolated in the vehicle by the use of the data store 110, and thereby inherently secure since malicious external sources are unable to write to the network 118 through the communications device 112, in accordance with the present disclosure.

While certain representative embodiments and details have been shown for purposes of illustrating the invention, it will be apparent to those skilled in the art that various changes may be made without departing from the scope of the disclosure, which is further described in the following appended claims.

What is claimed is:

1. A vehicle network system, comprising:
at least one module connected to a system of a vehicle; and
a connectivity module including a data store in communication with the at least one module and permitting read-only access of data from the at least one module by a communications device.

2. The vehicle network system of claim 1, wherein the system is a critical vehicle system.

3. The vehicle network system of claim 2, wherein the critical vehicle system is one of a powertrain system and a chassis system.

4. The vehicle network system of claim 1, wherein the system is a noncritical vehicle system.

5. The vehicle network system of claim 4, wherein the noncritical vehicle system is one of an audio system and a navigation system.

6. The vehicle network system of claim 1, wherein the communications device is a mobile phone.

7. The vehicle network system of claim 1, wherein the data store includes a buffer that temporarily holds the data from the at least one module for the read-only access by the communications device.

8. The vehicle network system of claim 7, wherein the at least one module has read/write access to the data store for writing the data to the buffer for the read-only access by the communications device.

9. The vehicle network system of claim 1, wherein the data store is at least one of hardware-based and software-based.

10. The vehicle network system of claim 1, wherein the connectivity module is an audio head unit.

11. The vehicle network system of claim 1, wherein the at least one module includes a first module, a second module, and a third module.

12. The vehicle network system of claim 11, wherein each of the first module, the second module, and the third module is in communication with a network.

13. The vehicle network system of claim 12, wherein there is read/write access between each of the first module, the second module, and the third module.

14. The vehicle network system of claim 13, further comprising an on-board diagnostic module in communication with first module, the second module, and the third module, the on-board diagnostic module permitting read/write access of the first module, the second module, and the third module.

15. The vehicle network system of claim 14, wherein the third module is connected to a safety system of the vehicle.

16. A vehicle network system, comprising:
a plurality of modules connected to one another over a network, each of the modules connected to a system of a vehicle;
an on-board diagnostic module in communication with the plurality of modules, the on-board diagnostic module permitting read/write access of the plurality of modules; and
a connectivity module including a data store in communication with the plurality of modules and permitting read-only access of data from the plurality of modules by a communications device.

17. A method for operating a vehicle network system including at least one module connected to a system of a vehicle, and a connectivity module including a data store in communication with the at least one module and permitting read-only access of data from the at least one module by a communications device, the method comprising the steps of:
permitting the communications device to communicate with the connectivity module;
causing the data to be written by the at least one module to the data store of the connectivity module for read-only access by the communications device if the communication from the communications device to the connectivity module is a read request; and
blocking a writing to the at least one module by the communications device if the communication from the communications device to the connectivity module is a write request.

18. The method of claim 17, wherein the read request is a request for performance data related to the system to which the at least one module is connected.

19. The method of claim 17, wherein the write request is a request to modify software of the at least one module.

20. The method of claim 17, wherein the system includes an on-board diagnostic module in communication with the at least one module, the on-board diagnostic module permitting read/write access to the at least one module, and the method includes a step of:
permitting the writing to the at least one module through the on-board diagnostic module.
